(19) United States
(12) Patent Application Publication
(10) Pub. No.: US 2024/0055188 A1
(43) Pub. Date: Feb. 15, 2024

(54) MULTILAYERED CAPACITOR AND METHOD FOR MANUFACTURING THE SAME

(71) Applicant: SAMSUNG ELECTRO-MECHANICS CO., LTD., Suwon-si (KR)

(72) Inventors: Kyeongjun Kim, Suwon-si (KR); Dongkyu Kim, Suwon-si (KR); Mikyeong Kim, Suwon-si (KR); Hyungoo Jeong, Suwon-si (KR); Hoin Jun, Suwon-si (KR)

(73) Assignee: SAMSUNG ELECTRO-MECHANICS CO., LTD., Suwon-si (KR)

(21) Appl. No.: 18/110,553

(22) Filed: Feb. 16, 2023

(30) Foreign Application Priority Data
Aug. 12, 2022 (KR) 10-2022-0101047

(51) Int. Cl. H01G 4/30; H01G 4/232; H01G 4/12; H01G 2/06

(52) U.S. Cl. CPC H01G 4/302; H01G 4/232; H01G 4/12; H01G 2/065

(57) ABSTRACT

A multilayered capacitor according to an embodiment includes a capacitor body including a dielectric layer, and a first internal electrode and a second internal electrode with the dielectric layer interposed therebetween, and an external electrode on one surface of the capacitor body. The first internal electrode has a first through-portion penetrating the first internal electrode, a dielectric of the dielectric layer is disposed in at least a portion of the first through-portion, and the first through-portion is disposed in a region where the first internal electrode is not overlapped with the second internal electrode.

### CROSS-REFERENCE TO RELATED APPLICATION

This application claims priority to and the benefit of Korean Patent Application No. 10-2022-0101047 filed in the Korean Intellectual Property Office on Aug. 12, 2022, the entire contents of which are incorporated herein by reference.

### TECHNICAL FIELD

This disclosure relates to a multilayered capacitor and a method for manufacturing the same.

### BACKGROUND

Multilayered capacitors are used in various electronic devices because they are small and have high capacity.

In particular, a high-voltage multilayered capacitor for an electric device for a vehicle is manufactured by applying a conductive paste onto a dielectric green sheet to form a printed film for an internal electrode and then, laminating the dielectric green sheet in several tens to hundreds of layers.

Herein, when a high voltage electric field is applied thereto, length expansion occurs in a thickness (T) direction (electric field direction), but length contraction occurs in a width (VV) direction (reverse piezoelectric effect).

This phenomenon occurs because dipoles in a ferroelectric, for example, BaTiO₃, are aligned in one direction by the electric field, which is in a parallel direction to the electric field.

At this time, when a stress greater than a threshold value is applied to the multilayered capacitor, cracks may be generated. Therefore, it is necessary to suppress the occurrence of cracks due to such a piezoelectric phenomenon in the high-voltage multilayered capacitor for electric use.

### SUMMARY

One aspect of the present disclosure may provide a multilayered capacitor capable of suppressing deformation and cracking due to a piezoelectric phenomenon by strengthening a bonding force between an internal electrode and a dielectric layer to reduce a piezoelectric behavior of the multilayered capacitor.

A multilayered capacitor according to one aspect includes a capacitor body including a first dielectric layer, and a first internal electrode and a second internal electrode with the first dielectric layer interposed therebetween, and an external electrode on one surface of the capacitor body. The first internal electrode has a first through-portion penetrating the first internal electrode and a dielectric of the first dielectric layer is disposed in at least a portion of the first through-portion.

The first through-portion may be disposed in a region where the first internal electrode is not overlapped with the second internal electrode.

The second internal electrode may have a second through-portion penetrating the second internal electrode, and a dielectric of the first dielectric layer may be disposed in at least a portion of the second through-portion. The second through-portion may be disposed in a region where the second internal electrode is not overlapped with the first internal electrode.

The capacitor body may include an active region in which the first internal electrode and the second internal electrode are overlapped.

The capacitor body may include a first end region in which the first internal electrode is not overlapped with the second internal electrode.

The capacitor body may include a second end region in which the second internal electrode is not overlapped with the first internal electrode.

The first through-portion may be disposed in the first end region.

The second through-portion may be disposed in the second end region.

The first through-portion may not be disposed in the active region.

The second through-portion may not be disposed in the active region.

The first through-portion may extend in a thickness direction of the first internal electrode to connect the first dielectric layer, and a second dielectric layer, and the first internal electrode may be disposed between the first dielectric layer and the second dielectric layer.

The second through-portion may extend in a thickness direction of the second internal electrode to connect the first dielectric layer and a third dielectric layer, and the second internal electrode may be disposed between the first dielectric layer and the third dielectric layer.

The capacitor body may include a plurality of first internal electrodes, and dielectrics in the first through-portions of the plurality of first internal electrodes may be connected to each other to have a pillar shape extending in a stacking direction of the plurality of first internal electrodes.

The capacitor body may include a plurality of second internal electrodes, and dielectrics in the second through-portions of the plurality of second internal electrodes may be connected to each other to have a pillar shape extending in a stacking direction of the plurality of second internal electrodes.

The first internal electrode may include a plurality of first through-portions.

The second internal electrode may include a plurality of second through-portions.

The plurality of first through-portions may be spaced apart from each other in a width direction of the first internal electrode.

The plurality of second through-portions may be spaced apart from each other in a width direction of the second internal electrode.

In the longitudinal direction of the first internal electrode, an average length of the first through-portion may be smaller than an average length of the first end region.

In the longitudinal direction of the second internal electrode, an average length of the second through-portion may be smaller than an average length of the second end region.

In the width direction of the first internal electrode, a sum of average lengths of the plurality of first through-portions and average distances between the plurality of first through-portions may be less than an average length of the first end region.

In the width direction of the second internal electrode, a sum of the average lengths of the plurality of second through-portions and the average distances between the plurality of second through-portions may be less than am average length of the second end region.

According to another aspect, a method for manufacturing a multilayered capacitor includes forming a first conductive paste layer having a first through-hole on a surface of a first dielectric green sheet, and a second conductive paste layer having a second through-hole on a surface of a second dielectric green sheet; preparing a dielectric green sheet laminate by laminating the first dielectric green sheet and the second dielectric green sheet so that the first through-hole is not overlapped with the second conductive paste layer, sintering the dielectric green sheet laminate to manufacture a capacitor body, and forming an external electrode on one surface of the capacitor body. The first dielectric green sheet, the second dielectric green sheet, or both are penetrated into the first through-hole.

In the manufacturing of the dielectric green sheet laminate, the first dielectric green sheet and the second dielectric green sheet may be laminated so that the second through-hole is not overlapped with the first conductive paste layer.

The first dielectric green sheet, the second dielectric green sheet, or both may be penetrated into the second through-hole.

In the manufacturing of the dielectric green sheet laminate, the first dielectric green sheet and the second dielectric green sheet may be laminated so that the first conductive paste layer and the second conductive paste layer are at least partially overlapped.

The method of manufacturing the multilayered capacitor may further include pressing the dielectric green sheet laminate.

In the manufacturing of the dielectric green sheet laminate, the pressing of the dielectric green sheet laminate, or both, the first dielectric green sheet, the second dielectric green sheet, or both may be penetrated into the first through-hole.

In the manufacturing of the dielectric green sheet laminate, the pressing of the dielectric green sheet laminate, or both, the first dielectric green sheet, the second dielectric green sheet, or both may be penetrated into the second through-hole.

The method of manufacturing the multilayered capacitor may further include cutting the dielectric green sheet laminate so that one end of the first internal electrode is exposed to one side of the dielectric green sheet laminate.

The cutting of the dielectric green sheet laminate may include cutting the dielectric green sheet laminate so that one end of the second internal electrode is exposed to the other side of the dielectric green sheet laminate.

According to the multilayered capacitor according to one aspect, by strengthening the bonding force between the internal electrode and the dielectric layer to reduce the piezoelectric behavior of the multilayered capacitor, deformation and cracks due to the piezoelectric phenomenon can be suppressed.

### BRIEF DESCRIPTION OF THE DRAWINGS

FIG. 1 is a perspective view illustrating a multilayered capacitor according to an embodiment.

FIG. 2 is a cross-sectional view of the multilayered capacitor taken along line I-I′ of FIG. 1.

FIG. 3 is an exploded perspective view illustrating a laminate structure of internal electrodes in the capacitor body of FIG. 1.

FIG. 4 is a plan view illustrating another example of the internal electrodes of FIG. 3.

FIG. 5 is a photograph showing a cut surface in the X-Z direction of the multilayered capacitor manufactured in Example 1.

FIG. 6 is a photograph showing a cut surface in the X-Y direction of the multilayered capacitor manufactured in Example 1.

FIG. 7 is a photograph showing a cut surface in the X-Y direction of the multilayered capacitor manufactured in Example 2.

FIG. 8 is a graph showing piezoelectric curves of multilayered capacitors manufactured in Examples 1 and 2 and Comparative Examples 1 and 2.

FIG. 9 is a graph showing the insulation break-down voltage (BDV) of the multilayered capacitors manufactured in Examples 1 and 2 and Comparative Examples 1 and 2.

### DETAILED DESCRIPTION

The present disclosure will be described more fully hereinafter with reference to the accompanying drawings, in which embodiments of the disclosure are shown. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present disclosure includes all modifications, equivalents, and substitutions without departing from the scope and spirit of the present disclosure.

Terms including ordinal numbers such as first, second, and the like will be used only to describe various constituent elements, and are not to be interpreted as limiting these constituent elements. The terms are only used to differentiate one constituent element from other constituent elements.

It is to be understood that when one constituent element is referred to as being “connected” or “coupled” to another constituent element, it may be connected or coupled directly to the other constituent element or may be connected or coupled to the other constituent element with a further constituent element intervening therebetween. In contrast, it should be understood that, when it is described that an element is “directly coupled” or “directly connected” to another element, no element is present between the element and the other element.

Throughout the specification, it should be understood that the term “include,” “comprise,” “have,” or “configure” indicates that a feature, a number, a step, an operation, a constituent element, a part, or a combination thereof described in the specification is present, but does not exclude a possibility of presence or addition of one or more other features, numbers, steps, operations, constituent elements, parts, or combinations, in advance. Unless explicitly described to the contrary, the word “comprise” and variations such as “comprises” or “comprising” will be understood to imply the inclusion of stated elements but not the exclusion of any other elements.

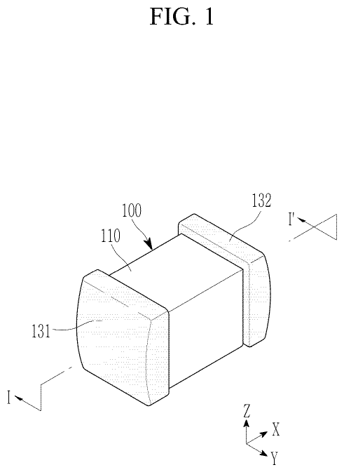

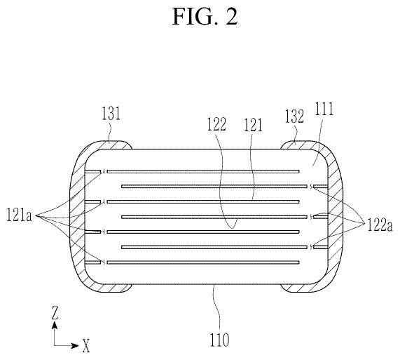

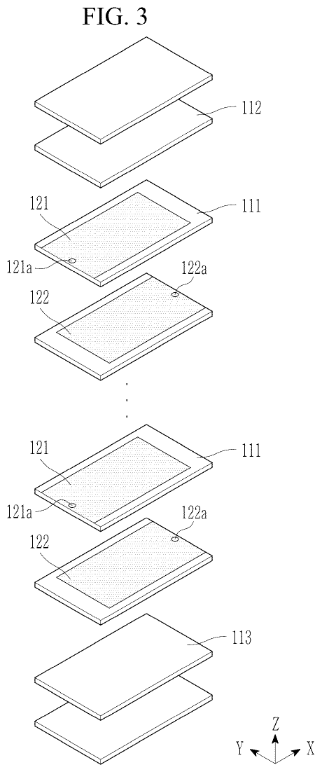

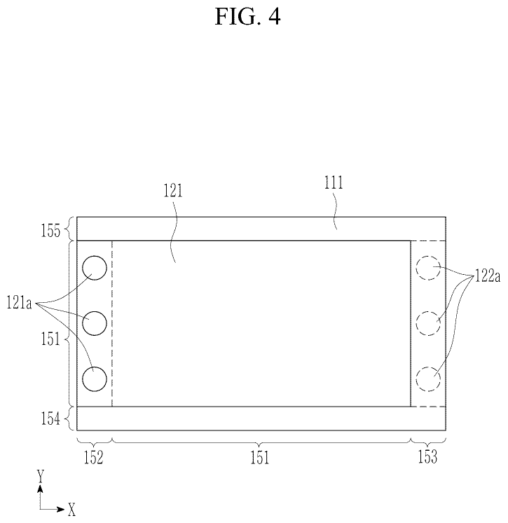

FIG. 1 is a perspective view illustrating a multilayered capacitor 100 according to an embodiment, FIG. 2 is a cross-sectional view of the multilayered capacitor 100 taken along line I-I′ of FIG. 1, FIG. 3 is an exploded perspective view illustrating a laminate structure of the internal electrodes 121 and 122 in the multilayered capacitor 100 according to an embodiment, and FIG. 4 is a plan view illustrating another example of the internal electrodes 121 and 122 of FIG. 3.

In order to clearly describe the present embodiment, X, Y, and Z directions in the drawings are respectively defined as a length (L) direction, a width (VV) direction, and a thickness (T) direction of a capacitor body 110. Herein, the thickness direction (Z direction) may be used in the same concept as a laminating direction in which dielectric layers 111 are laminated. The longitudinal direction (X direction) may be defined as an approximately perpendicular direction with respect to the thickness direction (Z direction), and the width direction (Y direction) may be defined as an approximately vertical direction with respect to the thickness direction (Z direction). In addition, the longitudinal direction (X direction) may indicate a direction having a length longer than the width direction (Y direction) among directions approximately perpendicular to the thickness direction (Z direction).

Referring to FIGS. 1 to 4, the multilayered capacitor 100 according to the present embodiment may include the capacitor body 110 and first and second external electrodes 131 and 132 disposed at both ends of the capacitor body 110 which face each other in the X direction.

The capacitor body 110 is formed by laminating a plurality of the dielectric layers 111 in the Z direction and then sintering them, and includes the plurality of dielectric layers 111 and a plurality of first and second internal electrodes 121 and 122 alternately interposed therebetween in the Z direction. Herein, the first and second internal electrodes 121 and 122 may have different polarities.

Herein, the boundary between the respective dielectric layers 111 adjacent to each other of the capacitor body 110 may be integrated to the extent that it is difficult to check without using a scanning electron microscope (SEM).

Also, the capacitor body 110 may include an active region 151 and cover regions 112 and 113.

The active region 151 contributes to forming capacitance of the multilayered capacitor 100. For example, the active region 151 is a region where the first and second internal electrodes 121 and 122 are laminated and overlapped with each other along the Z direction.

The cover regions 112 and 113 may be respectively disposed on the first and second surfaces of the active region 151 in the thickness direction (Z direction) as margin portions. The cover regions 112 and 113 may be formed by laminating a single dielectric layer 111 or two or more dielectric layers 111 on an upper surface and a lower surface of the active region 151, respectively.

Also, the capacitor body 110 may further include side cover regions 154 and 155. The side cover regions 154 and 155 may be respectively disposed on the fifth and sixth surfaces of the active region 151 in the width direction (Y direction) as margin portions. These side cover regions 154 and 155 may be formed by applying a conductive paste layer for forming internal electrodes on the surface of the dielectric green sheet only to a portion of the surface of the dielectric green sheet, laminating dielectric green sheets to which a conductive paste layer is not applied, on both side surfaces of the dielectric green sheet, and sintering the same.

The cover regions 112 and 113 and the side cover regions 154 and 155 serve to prevent damages to the first and second internal electrodes 121 and 122 due to physical or chemical stress.

The capacitor body 110 may have, for example, a substantially hexahedral shape.

In the present embodiment, for better understanding and ease of description, both surfaces of the capacitor body 110 facing each other in the thickness direction (Z direction) are defined as first and second surfaces, the surfaces thereof facing each other in the longitudinal direction (X direction) and connected to the first and second surfaces are defined as third and fourth surfaces, and the surfaces connected to the first and second surfaces and also to the third and fourth surfaces and facing each other in the width direction (Y direction) are defined as fifth and sixth surfaces. For example, the first surface, which is a bottom surface, may be a surface facing a mounting direction.

The shape and dimensions of the capacitor body 110 and the number of laminated dielectric layers 111 are not limited to those shown in the drawings of the present embodiment.

For example, the dielectric layer 111 may include a ceramic material with a high dielectric constant. For example, the ceramic material may include a dielectric ceramic including a component such as BaTiO₃, CaTiO₃, SrTiO₃, CaZrO₃, or the like. Further, in addition to these components, auxiliary components such as a Mn compound, an Fe compound, a Cr compound, a Co compound, a Ni compound, and the like may be further included. For example, (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, or the like in which Ca and Zr are partially dissolved in a BaTiO₃-based dielectric ceramic may be included.

In addition, in the dielectric layer 111, a ceramic additive, an organic solvent, a plasticizer, a binder, a dispersing agent, and the like along with the ceramic powder may be further added. The ceramic additive may be, for example, a transition metal oxide or a transition metal carbide, a rare earth element, magnesium (Mg), aluminum (Al), or the like.

For example, the dielectric layer 111 may have an average thickness of about 0.5 μm to about 10 μm.

The first and second internal electrodes 121 and 122 are electrodes having different polarities, are alternately disposed to face each other in the thickness direction (Z direction) with the dielectric layer 111 in the middle, and one of ends thereof may be exposed through (or extend from or be in contact with) the third or fourth surface of the capacitor body 110.

The first and second internal electrodes 121 and 122 may be electrically insulated by the dielectric layer 111 disposed therebetween.

The ends of the first and second internal electrodes 121 and 122 alternately exposed through the third and fourth surfaces of the capacitor body 110 may be electrically connected to the first and second external electrodes 131 and 132, respectively.

The first and second internal electrodes 121 and 122 may include a conductive metal, for example, a metal such as Ni, Cu, Ag, Pd, or Au, or an alloy thereof, for example, an Ag—Pd alloy.

In addition, the first and second internal electrodes 121 and 122 may include dielectric particles having the same composition as the ceramic material included in the dielectric layer 111.

For example, the first and second internal electrodes 121 and 122 may have an average thickness of about 0.1 μm to about 2 μm.

According to the above configuration, when a predetermined voltage is applied to the first and second external electrodes 131 and 132, charges are accumulated between the first and second internal electrodes 121 and 122. Herein, capacitance of the multilayered capacitor 100 is proportional to an overlapped area of the first and second internal electrodes 121 and 122 laminated along the thickness direction (Z direction) in the active region 151.

However, in the case of the high-voltage multilayered capacitor 100 for an electric device for a vehicle, the capacitor body 110 is formed by laminating the first and second internal electrodes 121 and 122 from several tens to hundreds of layers. In this case, cracks are likely to occur due to piezoelectric phenomenon.

In order to solve this problem, a technique for reducing piezoelectric behavior by inserting a dielectric layer 111 thicker than other dielectric layers 111 as a buffer layer in the middle of the active region 151 of the capacitor body 110 is known. However, such an intermediate buffer layer has a disadvantage in that it is easy to generate cracks at the interface due to the difference in sinterability from the other dielectric layers 111.

Accordingly, the multilayered capacitor 100 according to the present embodiment is a new type of vertical buffer, in which the first internal electrode 121 has a first through-portion 121a. The dielectric of the dielectric layer 111 is disposed on at least a portion of the first through-portion 121a. For example, in the first through-portion 121a, the dielectric of the dielectric layer 111 may be formed through the first internal electrode 121. The first through-portion 121a is disposed in a region where the first internal electrode 121 is not overlapped with the second internal electrode 122.

In addition, the second internal electrode 122 has a second through-portion 122a. The dielectric of the dielectric layer 111 is disposed on at least a portion of the second through-portion 122a. For example, in the second through-portion 122a, the dielectric of the dielectric layer 111 may be formed through the second internal electrode 122. The second through-portion 122a is disposed in a region where the second internal electrode 122 is not overlapped with the first internal electrode 121.

In general, the bonding force between the first and second internal electrodes 121 and 122 and the dielectric layer 111 tends to be lower than the bonding force between the dielectric layers 111, and the first and second through-portions 121a and 122a serve as vertical buffers to strengthen the bonding force between the first and second internal electrodes 121 and 122 and the dielectric layer 111, thereby suppressing distortion due to electro-distortion.

The capacitor body 110 includes an active region 151 in which the first internal electrode 121 and the second internal electrode 122 are overlapped with each other, a first end region 152 in which the first internal electrode 121 is not overlapped with the second internal electrode 122, and a second end region 153 in which the second internal electrode 122 is not overlapped with the first internal electrode 121.

The first end region 152 and the second end region 153 are margin portions and may be respectively disposed on the third and fourth surfaces of the active region 151 in the longitudinal direction (X direction). These first and second end regions 152 and 153 may be formed by, when a dielectric green sheet laminate is manufactured by laminating a dielectric green sheet coated with a conductive paste layer for forming an internal electrode, by laminating the conductive paste layer for forming the first internal electrode and the conductive paste layer for forming the second internal electrode so that at least some regions are not overlapped with each other.

The first through-portion 121a may be disposed in the first end region 152, and the second through-portion 122a may be disposed in the second end region 153. Meanwhile, the first through-portion 121a may not be disposed in the active region 151, and the second through-portion 122a may not be disposed in the active region 151. That is, the first through-portion 121a may be disposed only in the first end region 152, and the second through-portion 122a may be disposed only in the second end region 153.

The first and second through-portions 121a and 122a are formed by not applying a conductive paste to the portion where the first and second through-portions 121a and 122a are to be formed when the conductive paste is applied to the surface of the dielectric green sheet, as will be described later, or alternatively after applying the conductive paste, the conductive paste in the portion where the first and second through-holes 121a and 122a are to be formed is removed using a laser drill or the like. The structure and shape thereof are different from random cut-off portions formed when a portion of the first and second internal electrodes 121 and 122 is cut during sintering due to the difference in the shrinkage start temperature of the conductive paste and the dielectric green sheet.

Also, accordingly, the first through-portion 121a may be disposed only in the first end region 152 and the second through-portion 122a may be disposed only in the second end region 153, but the cut-off portions are randomly formed over the entire regions of the second internal electrodes 121 and 122, and it is difficult to control the formation positions thereof, and in particular, it is more difficult to dispose them only in the first and second end regions 152 and 153.

The first through-portion 121a extends in the thickness direction (Z direction) of the first internal electrode 121, and the dielectrics in the first internal electrode 121 may connect between the two dielectric layers 111 on both sides in the thickness direction (Z direction) of the first internal electrode 121.

In addition, the second through-portion 122a extends in the thickness direction (Z direction) of the second internal electrode 122, and the dielectrics in the second internal electrode 122 may connect between the two dielectric layers 111 on both sides in the thickness direction (Z direction) of the second internal electrode 122.

At this time, the boundaries between the dielectrics in the first and second through-portions 121a and 122a and the dielectric layers 111 connected thereto is integrated to such an extent that it is difficult to check without using a scanning electron microscope (SEM).

The dielectrics in the first through-portions 121a of the first internal electrodes 121 may be substantially connected to each other and may have a pillar shape extending in the thickness direction (Z direction) of the first internal electrode 121. Here, the pillar shape may mean a shape of an even polyhedron having dihedral symmetry, and may have various shapes such as a cylinder, an elliptical pillar, or a polygonal pillar. The fact that the dielectrics are substantially connected to each other means that the first through-portions 121a are arranged in a line in the thickness direction (Z direction), which means that the dielectrics in the first through-portions 121a are continuously or discontinuously connected through the dielectrics in the dielectric layers 111.

In addition, dielectrics in the second through-portions 122a of the second internal electrodes 122 may also be connected to each other to have a pillar shape extending in the thickness direction (Z direction) of the second internal electrode 122.

The first internal electrode 121 may include a plurality of first through-portions 121a. Also, the second internal electrode 122 may include a plurality of second through-portions 122a. For example, FIG. 4 illustrates a case in which the first internal electrode 121 includes three first through-portions 121a and the second internal electrode 122 includes three second through-portions 122a.

The plurality of first through-portions 121a may be spaced apart from each other in the width direction (Y direction) of the first internal electrode 121. Also, the plurality of second through-portions 122a may be spaced apart from each other in the width direction (Y direction) of the second internal electrode 122. Even in this case, the first through-portions 121a may be disposed only in the first end region 152, and the second through-portions 122a may be disposed only in the second end region 153.

In the longitudinal direction (X direction) of the first internal electrode 121, the average length of the first through-portions 121a is smaller than the average length of the first end region 152.

The length of the first through-portion 121a is determined by polishing the multilayered capacitor 100 until any first internal electrodes 121 are exposed in a plane direction substantially perpendicular to the Z direction, and then the maximum diameter of any first through-portion 121a in the cut surface of the exposed first internal electrode 121 may be the length of the first through-portion 121a.

An average length of the first through-portions 121a may be an arithmetic mean of lengths of any three, five, or ten first through-portions 121a respectively in the different first internal electrodes 121, and when one first internal electrode 121 includes the plurality of first through-portions 121a, an arithmetic mean of lengths of a plurality of first through-portions 121a in one first internal electrode 121.

A length of the first end region 152 may be obtained by polishing the multilayered capacitor 100 until the first through-portion 121a and the second through-portion 122a are exposed, randomly selecting any first through-portion 121a from the cut surface thereof exposed in a plane direction substantially perpendicular to the Y direction, and measuring an X direction length of the first internal electrode 121 not overlapped with the adjacent second internal electrode 122.

An average length of the first end regions 152 may be an arithmetic mean of lengths of the first end regions 152 measured in any three, five, or ten different first internal electrodes 121 selected from the exposed cut surface.

In one example, a length or a dimension of an element may be measured by an optical microscope or a scanning electron microscope (SEM). Other methods and/or tools appreciated by one of ordinary skill in the art, even if not described in the present disclosure, may also be used.

In addition, in the longitudinal direction (X direction) of the second internal electrode 122, an average length of the second through-portions 122a is shorter than that of the second end regions 153.

In the longitudinal direction (X direction) of the first and second internal electrodes 121 and 122, the first and second through-portions 121a and 122a may have an average length of about 0.1 mm to about 1.0 mm. When the average length of the first and second through-portions 121a and 122a is less than about 0.1 mm, the dielectrics in the first and second through-portions 121a and 122a may be difficult to manufacture in a pillar shape, and when the average length is greater than about 1.0 mm, the dielectrics may invade the active region 151, deteriorating capacity.

In the longitudinal direction (X direction) of the first and second internal electrodes 121 and 122, an average length of the first and second end regions 152 and 153 may be about 0.1 mm to about 1.0 mm. When the average length of the first and second end regions 152 and 153 is less than 0.1 mm, the dielectrics in the first and second through-portions 121a and 122a may be difficult to manufacture in a pillar shape, and when the average length is greater than about 1.0 mm, the dielectrics may invade the active region 151, deteriorating capacity.

In the width direction (Y direction) of the first internal electrode 121, a sum of the average lengths of the plurality of first through-portions 121a and average distances between the plurality of first through-portions 121a is smaller than the average length of the first end regions 152.

The lengths of the plurality of first through-portion 121a may be obtained by polishing the multilayered capacitor 100 until any first internal electrode 121 is exposed in a plane direction substantially perpendicular to the Z direction and measuring a maximum diameter of each first through-portion 121a from the cut surface of the exposed first internal electrode 121.

The average lengths of the plurality of first through-portions 121a may be an arithmetic mean of lengths of a plurality of first through-portions 121a respectively disposed in any three, five or ten first internal electrodes 121.

The distances between the plurality of first through-portions 121a are obtained by polishing the multilayered capacitor 100 until any first internal electrode 121 is exposed in a plane direction substantially perpendicular to the Z direction and measuring the shortest distance between the plurality of first through-portions 121a on the cut surface of the exposed first internal electrode 121.

The average distances between the plurality of first through-portions 121a may be an arithmetic mean of the distances between a plurality of first through-portions 121a disposed in any three, five, or ten first internal electrodes 121.

In addition, in the width direction (Y direction) of the second internal electrode 122, a sum of the average lengths of the plurality of second through-portions 122a and the average distances of the plurality of second through-portions 122a is smaller than the average length of the second end regions 153.

The first and second external electrodes 131 and 132 may be provided with voltages having different polarities and electrically connected to the exposed portions of the first and second internal electrodes 121 and 122, respectively.

The first and second external electrodes 131 and 132 may respectively include first and second connection portions disposed on the third and fourth surfaces of the capacitor body 110 and respectively connected to the first and second internal electrodes 121 and 122, and also first and second band portions disposed at corners where the first and second surfaces of the capacitor body 110 meet the third and fourth surfaces thereof.

The first and second band portions may extend from the first and second connection portions to portions of the first and second surfaces of the capacitor body 110, respectively. The first and second band portions respectively may further extend from the first and second connection portions to the portions of the fifth and sixth surfaces of the capacitor body 110. The first and second band portions 1312 and 1322 may serve to improve adhesion strength of the first and second external electrodes 131 and 132.

For example, the first and second external electrodes 131 and 132 may respectively include first and second base electrodes in contact with the capacitor body 110, and also first and second terminal electrodes respectively covering the first and second base electrodes.

The first and second base electrodes may include copper (Cu). In addition, the first and second base electrodes may include copper (Cu) as a main component, one or more materials of nickel (Ni), tin (Sn), palladium (Pd), platinum (Pt), gold (Au), silver (Ag), tungsten (W), titanium (Ti), lead (Pb), or an alloy thereof, and glass.

For example, the first and second base electrodes may be formed in a method of dipping the capacitor body 110 in a conductive paste including a conductive metal and glass, printing the conductive paste on the surface of the capacitor body 110 through screen printing, gravure printing, or the like, and applying the conductive paste onto the surface of the capacitor body 110 or transferring a dry film formed by drying the conductive paste onto the capacitor body 110.

The first and second base electrodes are formed of the aforementioned conductive paste and thus may increase density of the first and second external electrodes 131 and 132 due to the glass added thereto as well as maintain sufficient conductivity, and thereby effectively suppress penetration of a plating solution and/or external moisture.

For example, the glass component included in the first and second base electrodes may have a composition in which oxides are mixed, and the metal oxides may be one or more selected from a silicon oxide, a boron oxide, an aluminum oxide, a transition metal oxide, an alkali metal oxide, and an alkali earth metal oxide. The transition metal may be selected from zinc (Zn), titanium (Ti), copper (Cu), vanadium (V), manganese (Mn), iron (Fe), and nickel (Ni), the alkali metal may be at least one selected from lithium (Li), sodium (Na), and potassium (K), and the alkaline earth metal may be at least one selected from magnesium (Mg), calcium (Ca), strontium (Sr), and barium (Ba).

For example, the first and second terminal electrodes may include nickel (Ni) as a main component, and may further include copper (Cu), tin (Sn), palladium (Pd), platinum (Pt), gold (Au), silver (Ag), tungsten (W), titanium (Ti), or lead (Pb) alone or as alloy thereof. The first and second terminal electrodes may improve mountability of the multilayered capacitor 100 on a board, structural reliability, external durability, heat resistance, and equivalent series resistance (ESR).

For example, the first and second terminal electrodes may be formed through plating. The first and second terminal electrodes may be formed through sputtering or electroplating (electric deposition).

Hereinafter, a method of manufacturing the multilayered capacitor 100 according to the present embodiment will be described.

A plurality of dielectric green sheets are prepared. The dielectric green sheet becomes the dielectric layer 111 of the capacitor body 110 after sintering.

The dielectric green sheets are made by mixing ceramic powder, a ceramic additive, an organic solvent, a plasticizer, a binder, a dispersing agent, and the like into a paste and forming the paste into a several μm-thick sheet in a method of doctor blade, screen printing, or the like.

For example, the ceramic powder may be powder of a ceramic material with a high dielectric constant. For example, the ceramic material may include a dielectric ceramic including a component such as BaTiO₃, CaTiO₃, SrTiO₃, or CaZrO₃, and the like. In addition, an auxiliary component such as an Mn compound, an Fe compound, a Cr compound, a Co compound, an Ni compound, and the like may be further included in these components. For example, (Ba₁₋ₓCaₓ)TiO₃, Ba(Ti_{1-y}Ca_{y})O₃, (Ba₁₋ₓCaₓ)(Ti_{1-y}Zr_{y})O₃, Ba(Ti_{1-y}Zr_{y})O₃, or the like in which Ca, Zr, etc. are partially dissolved in the BaTiO₃-based dielectric ceramic may be included.

The ceramic additive may include, for example, transition metal oxide or transition metal carbide, a rare earth element, magnesium (Mg), aluminum (Al), and the like.

A conductive paste layer is formed on the surface of the dielectric green sheet. The conductive paste layer becomes the first and second internal electrodes 121 and 122 after sintering.

The conductive paste layer may be formed by applying the conductive paste including a conductive metal on the surface of the dielectric green sheet in the method of doctor blade, screen printing, or the like.

The conductive metal may include, for example, a metal such as Ni, Cu, Ag, Pd, or Au, or an alloy thereof, for example, an Ag—Pd alloy.

For example, the first conductive paste layer may be applied onto the surface of the first dielectric green sheet in a first pattern, and the second conductive paste layer may be applied onto the surface of the second dielectric green sheet in a second pattern.

Herein, the first pattern and the second pattern may have, for example, a stripe shape, and when the first and second dielectric green sheets are alternatively laminated, the first pattern and the second pattern may be aligned so that portions of the first and second conductive paste layers are overlapped, while the other portions are not overlapped.

Herein, the conductive paste is applied so that the first and second conductive paste layers may respectively have first and second through-holes. For example, the first and second through-holes may be formed by not applying the conductive paste where the first and second through-holes are supposed to be formed when the conductive paste is applied or applying the conductive paste all onto the surface of the first and second dielectric green sheets and then, removing the conductive paste where the first and second through-holes are supposed to be formed by using a laser drill and the like.

The first and second dielectric green sheets are laminated to manufacture a dielectric green sheet laminate.

Herein, the first and second dielectric green sheets are laminated so that the first and second conductive paste layers may be overlapped, but at least portions of them may not be overlapped.

Specifically, the first and second dielectric green sheets are laminated so that the first through-hole may not be overlapped with the second conductive paste layer. In addition, the first and second dielectric green sheets are laminated so that the second through-hole may not be overlapped with the first conductive paste layer. Accordingly, the capacitor body 110 may include the active region 151 where the first internal electrode 121 is overlapped with the second internal electrode 122, the first end region 152 where the first internal electrode 121 is not overlapped with the second internal electrode 122, and the second end region 153 where the second internal electrode 122 is not overlapped with the first internal electrode 121.

Optionally, the dielectric green sheet laminate is pressed.

In the manufacturing of the dielectric green sheet laminate, the pressing the dielectric green sheet laminate, or both, the first dielectric green sheet, the second dielectric green sheet, or both are penetrated into the first through-hole. In addition, in the manufacturing of the dielectric green sheet laminate, the pressing the dielectric green sheet laminate, or both of them, the first dielectric green sheet, the second dielectric green sheet, or both of them penetrate into the second through-hole.

In the laminating or pressing the dielectric green sheet laminate, pore collapse, binder flow, and particle rearrangement of the dielectric green sheet are in progress, wherein this flow of the dielectric green sheet may be used to fill the first through-hole and the second through-hole of the first and second conductive paste layers with the dielectric green sheet.

Accordingly, the first internal electrode 121 includes the first through-portion 121a formed by the first or second dielectric green sheet penetrating into the first through-hole, and the second internal electrode 122 includes the second through-portion 122a formed by the first or second dielectric green sheet penetrating into the second through-hole.

The first and second through-portions 121a and 122a are formed by sintering the first and second dielectric green sheet after the penetrating and may extend in the thickness direction of the first and second internal electrodes 121 and 122 and thus connect two dielectric layers 111 at both sides in the thickness direction (Z direction) of the first and second internal electrodes 121 and 122.

In addition, a boundary between the dielectric layers 111 connected with the first and second through-portions 121a and 122a may be integrated to such an extent as not to check without a scanning electron microscope (SEM).

Optionally, the dielectric green sheet laminate may be cut so that the first and second conductive paste layers are respectively exposed through both end surfaces.

The dielectric green sheet laminate may be sintered at a high temperature, manufacturing the capacitor body 110.

The first and second external electrodes 131 and 132 are respectively formed on both of the end surfaces where the first and second internal electrodes 121 and 122 of the capacitor body 110 are respectively exposed.

The first and second external electrodes 131 and 132 may be, for example, formed by applying the conductive paste and sintering the same or plating the conductive paste on the capacitor body 110. In addition, the first and second external electrodes 131 and 132 may be formed by applying the conductive paste on the dielectric green sheet laminate and then, sintering the conductive paste along with the dielectric green sheet laminate.

Hereinafter, specific examples are presented. However, the examples described below are only for specifically illustrating or explaining the present disclosure, and the scope of the present disclosure is not limited thereto.

### Preparation Example: Manufacture of Multilayered Capacitor

### Example 1

A paste including barium titanite (BaTiO₃) powder is applied onto a carrier film and dried, forming a plurality of 1.8 μm-thick dielectric green sheets.

A conductive paste including nickel is applied through screen printing on the dielectric green sheet but not applied where a through-hole is supposed be formed, forming a conductive paste layer with the through-hole.

Herein, the through-hole is shaped to have an average diameter of 0.3 mm and an average length of 1.5 mm, wherein one through-hole is formed for each conductive paste layer.

A dielectric green sheet laminate is manufactured by laminating about 100 dielectric green sheets, so that the through-hole may not be overlapped with the conductive paste layer.

The dielectric green sheet laminate is isostatically pressed at 85° C. under a pressure of 1000 kgf/cm².

The pressed dielectric green sheet laminate is cut into an individual chip and maintained at 230° C. for 60 hours under an air atmosphere to remove a binder.

Subsequently, the obtained laminate chips are sintered at 1200° C. under a lower oxygen partial pressure of 10⁻¹¹ atm to 10⁻¹⁰ atm than a Ni/NiO equilibrium oxygen partial pressure under a reduction atmosphere, so that an internal electrode may not be oxidized.

Then, a multilayered capacitor (L×W×T=3.2 mm×1.6 mm×1.6 mm) is manufactured through processes of forming an external electrode, plating it, and the like.

### Example 2

A multilayered capacitor is manufactured in the same manner as in Example 1 except that three through-holes are formed for each conductive paste layer.

### Comparative Example 1

A multilayered capacitor is manufactured in the same manner as in Example 1 except that the through-hole is not formed for each conductive paste layer.

### Comparative Example 2

A paste including barium titanite (BaTiO₃) powder is applied onto a carrier film and dried to form a plurality of 1.8 μm-thick dielectric green sheets.

A conductive paste including nickel is applied through screen printing on the dielectric green sheets to form a conductive paste layer.

A dielectric green sheet laminate is manufactured by laminating about 100 dielectric green sheets and inserting a dielectric green sheet with no conductive paste layer thereinto as a buffer layer.

The dielectric green sheet laminate into which the buffer layer is inserted is isostatically pressed at 85° C. under a pressure of 1000 kgf/cm².

The pressed dielectric green sheet laminate is cut into individual chips and maintained under an air atmosphere at 230° C. for 60 hours to remove a binder.

Subsequently, the cut laminate chips are sintered at 1200° C. under a lower oxygen partial pressure of 10⁻¹¹ atm to 10⁻¹⁰ atm than a Ni/NiO equilibrium oxygen partial pressure under a reduction atmosphere, so that an internal electrode may not be oxidized.

Then, a multilayered capacitor (L×W×T=3.2 mm×1.6 mm×1.6 mm) is manufactured through processes of forming an external electrode, plating it, and the like.

### Experimental Example 1: Internal Structure of Multilayered Capacitor

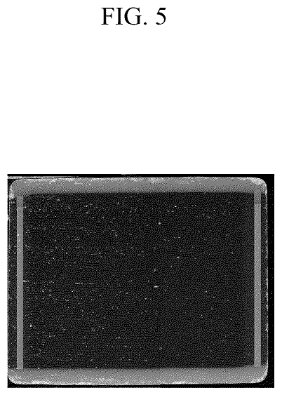

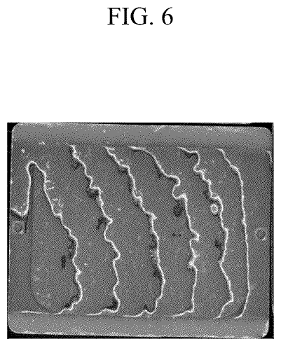

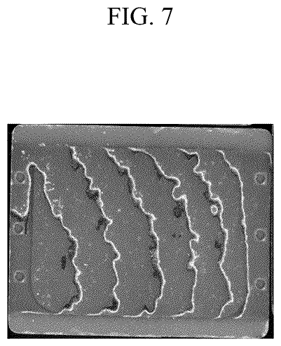

FIG. 5 is a photograph showing a cut surface in the X-Z direction of the multilayered capacitor manufactured in Example 1, FIG. 6 is a photograph showing a cut surface in the X-Y direction of the multilayered capacitor manufactured in Example 1, and FIG. 7 is a photograph showing a cut surface in the X-Y direction of the multilayered capacitor manufactured in Example 2.

Referring to FIGS. 5 to 7, since the dielectric green sheets flow and penetrate into the through-hole on which the conductive paste is not applied during the lamination or the pressing, the internal electrode includes a penetrating portion through which the dielectric layer penetrates in the end region.

In addition, referring to FIG. 5, dielectrics in first through-portions of a plurality of first internal electrodes are connected to each other and have a pillar shape extending in a thickness direction of the first internal electrodes, and dielectrics in second through-portions of a plurality of second internal electrodes have a pillar shape extended in a thickness direction of the second internal electrodes.

### Experimental Example 2: Measurement of Piezoelectric Curve of Multilayered Capacitor

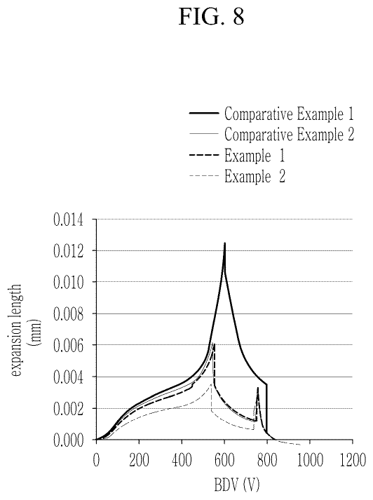

The multilayered capacitors of Examples 1 and 2 and Comparative Examples 1 and 2 are measured with respect to a piezoelectric curve, and the results are shown in FIG. 8.

The piezoelectric curve is a graph showing a longitudinal (X direction) expansion length (mm) of each multilayered capacitor with respect to an insulation break-down voltage (BDV).

The insulation break-down voltage is obtained by applying a voltage from 0 V to 1.00000 V in a sweep method and measuring a voltage when a current becomes 20 mA with a Keithely measuring instrument.

Referring to FIG. 8, the multilayered capacitor of Comparative Example 1 exhibits the greatest degree of expansion in the thickness direction, the multilayered capacitor of Example 1 exhibits expansion in the thickness direction to the same level as the multilayered capacitor of Comparative Example 2, and the multilayered capacitor of Example 2 exhibits the smallest expansion in the thickness direction.

### Experimental Example 3: Measurement of Insulation Break-Down Voltage of Multilayered Capacitors

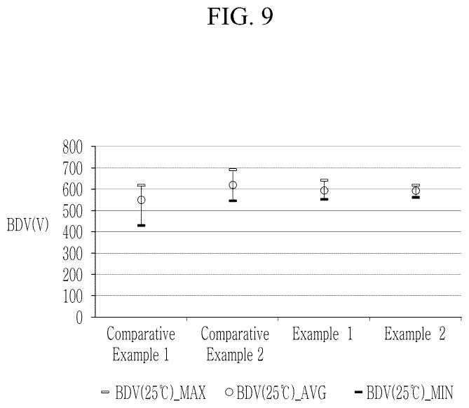

The multilayered capacitors of Examples 1 and 2 and Comparative Examples 1 and 2 are measured with respect to the insulation break-down voltage (BDV), and the results are shown in FIG. 9.

The insulation break-down voltage is obtained by applying a voltage from 0 V to 1.00000 V in a sweep method and measuring a voltage when a current becomes 20 mA with a Keithely measuring instrument.

Referring to FIG. 9, the multilayered capacitors of Comparative Examples 1 and 2 exhibit a large distribution, and Examples 1 and 2 realize an equal or higher insulation break-down voltage than that of the multilayered capacitor of Comparative Example 2 and thus exhibits reduced distribution.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

What is claimed is:

1. A multilayered capacitor, comprising
a capacitor body including a first dielectric layer, and a first internal electrode and a second internal electrode with the first dielectric layer interposed therebetween, and
an external electrode on one surface of the capacitor body,
wherein the first internal electrode has a first through-portion penetrating the first internal electrode and a dielectric of the first dielectric layer is disposed in at least a portion of the first through-portion, and
the first through-portion is disposed in a region where the first internal electrode is not overlapped with the second internal electrode.

2. The multilayered capacitor of claim 1, wherein
the second internal electrode has a second through-portion penetrating the second internal electrode and a dielectric of the first dielectric layer is disposed in at least a portion of the second through-portion, and
the second through-portion is disposed in a region where the second internal electrode is not overlapped with the first internal electrode.

3. The multilayered capacitor of claim 2, wherein
the capacitor body includes an active region in which the first internal electrode and the second internal electrode are overlapped,
a first end region in which the first internal electrode is not overlapped with the second internal electrode, and
a second end region in which the second internal electrode is not overlapped with the first internal electrode.

4. The multilayered capacitor of claim 3, wherein
the first through-portion is disposed in the first end region, and
the second through-portion is disposed in the second end region.

5. The multilayered capacitor of claim 3, wherein
the first through-portion is not disposed in the active region, and
the second through-portion is not disposed in the active region.

6. The multilayered capacitor of claim 2, wherein
the first through-portion extends in a thickness direction of the first internal electrode to connect the first dielectric layer and a second dielectric layer,
the second through-portion extends in a thickness direction of the second internal electrode to connect the first dielectric layer and a third dielectric layer,
the first internal electrode is disposed between the first dielectric layer and the second dielectric layer, and
the second internal electrode is disposed between the first dielectric layer and the third dielectric layer.

7. The multilayered capacitor of claim 1, wherein
the capacitor body includes a plurality of first internal electrodes, and
dielectrics in the first through-portions of the plurality of first internal electrodes are connected to each other to have a pillar shape extending in a stacking direction of the plurality of first internal electrodes.

8. The multilayered capacitor of claim 2, wherein
the capacitor body includes a plurality of second internal electrodes, and
dielectrics in the second through-portions of the plurality of second internal electrodes are connected to each other to have a pillar shape extending in a stacking direction of the plurality of second internal electrodes.

9. The multilayered capacitor of claim 2, wherein
the first internal electrode includes a plurality of first through-portions, and
the second internal electrode includes a plurality of second through-portions.

10. The multilayered capacitor of claim 9, wherein
the plurality of first through-portions are spaced apart from each other in a width direction of the first internal electrode, and
the plurality of second through-portions are spaced apart from each other in a width direction of the second internal electrode.

11. The multilayered capacitor of claim 3, wherein
in a longitudinal direction of the first internal electrode, an average length of the first through-portion is smaller than an average length of the first end region, and
in a longitudinal direction of the second internal electrode, an average length of the second through-portion is smaller than an average length of the second end region.

12. The multilayered capacitor of claim 9, wherein
in a width direction of the first internal electrode, a sum of average lengths of the plurality of first through-portions and average distances between the plurality of first through-portions is less than an average length of the first end region, and
in a width direction of the second internal electrode, a sum of the average lengths of the plurality of second through-portions and the average distances between the plurality of second through-portions is less than am average length of the second end region.

13. A method for manufacturing a multilayered capacitor, comprising
forming a first conductive paste layer having a first through—hole on a surface of a first dielectric green sheet, and a second conductive paste layer having a second through-hole on a surface of a second dielectric green sheet;
preparing a dielectric green sheet laminate by laminating the first dielectric green sheet and the second dielectric green sheet so that the first through-hole is not overlapped with the second conductive paste layer;
sintering the dielectric green sheet laminate to manufacture a capacitor body; and
forming an external electrode on one surface of the capacitor body,
wherein the first dielectric green sheet, the second dielectric green sheet, or both are penetrated into the first through-hole.

14. The method of claim 13, wherein
in the manufacturing of the dielectric green sheet laminate, the first dielectric green sheet and the second dielectric green sheet are laminated so that the second through-hole is not overlapped with the first conductive paste layer, and
the first dielectric green sheet, the second dielectric green sheet, or both are penetrated into the second through-hole.

15. The method of claim 13, wherein
in the manufacturing of the dielectric green sheet laminate, the first dielectric green sheet and the second dielectric green sheet are laminated so that the first conductive paste layer and the second conductive paste layer are at least partially overlapped.

16. The method of claim 13, further comprising pressing the dielectric green sheet laminate.

17. The method of claim 16, wherein
in the manufacturing of the dielectric green sheet laminate, the pressing of the dielectric green sheet laminate, or both, the first dielectric green sheet, the second dielectric green sheet, or both are penetrated into the first through-hole.

18. The method of claim 16, wherein
in the manufacturing of the dielectric green sheet laminate, the pressing of the dielectric green sheet laminate, or both, the first dielectric green sheet, the second dielectric green sheet, or both are penetrated into the second through-hole.

19. The method of claim 13, further comprising cutting the dielectric green sheet laminate so that one end of the first internal electrode is exposed to one side of the dielectric green sheet laminate.

20. The method of claim 19, wherein
the cutting of the dielectric green sheet laminate includes cutting the dielectric green sheet laminate so that one end of the second internal electrode is exposed to the other side of the dielectric green sheet laminate.
